(19) United States
(12) Patent Application Publication
(10) Pub. No.: US 2015/0319458 A1
(43) Pub. Date: Nov. 5, 2015

(54) METHODS AND APPARATUS FOR AUTOMATICALLY DETECTING IMAGE/VIDEO RESOLUTION AND ITS COLOR SUBSAMPLING

(71) Applicant: THOMSON LICENSING, Issy de Moulineaux (FR)

(72) Inventors: LiHua ZHU, San Jose, CA (US); Anton TE, Lake Forest, CA (US); Jesus Barcons-Palau, Redmond, WA (US); Richard Edwin GOEDEKEN, Santa Clarita, CA (US)

(21) Appl. No.: 14/649,060

(22) PCT Filed: Dec. 19, 2012
(86) PCT No.: PCT/US2012/070682

§ 371 Date: Jun. 2, 2015

(51) Int. Cl. H04N 19/59; H04N 21/44; H04N 19/587; H04N 19/14

(52) U.S. Cl. CPC H04N 19/59; H04N 19/14; H04N 21/44008; H04N 19/587

(57) ABSTRACT

Methods and apparatus for automatic detection of image or video resolution from raw image or video data are provided by the present principles. The methods find statistical metrics in the image or video data based on a look-up table of potential resolution and subsampling combinations. The methods compute statistics comprising spatial correlation, temporal correlation, and variances in addition to considering color sampling and luminance levels. The methods determine the strength of correlation between portions of the raw image or video data and find the best match between the data and a plurality of possible resolution and subsampling formats.

### FIELD OF THE INVENTION

The present principles relate to methods and apparatus for automatic detection of image or video resolution and color subsampling format from raw image or video data.

### BACKGROUND OF THE INVENTION

Image or video sequences often arrive in a studio environment in various resolutions and using one of several common color subsampling formats. The resolution and color subsampling format of these sequences is generally not known in advance. Large studios handle many such sequences. Many of these are in formats such as YUV, for example, and it would be a time consuming task to manually input the video resolution and subsampling format prior to processing every sequence. A compressionist would need to try various possible resolutions one by one, and, in the case of YUV sequences, this process would be even more time-consuming because YUV sequences do not have the capability to store metadata for the resolution and subsampling information.

These problems are addressed by the principles described herein which provide methods and apparatus for automatic detection of image or video resolution and color subsampling format from raw image or video data. The methods determine the strength of correlation in raw images or video sequences and find the best match between the data sequence and various resolution and subsampling possibilities.

### SUMMARY OF THE INVENTION

The principles described herein relate to a method and an apparatus for automatic detection of resolution and color subsampling format from raw images or video sequences.

The methods disclosed herein find the image or video resolution and color subsampling format by calculating statistical metrics from raw video data sequences based on a look-up table of potential resolution/color subsampling combinations. The metrics comprise spatial and temporal statistics, such as correlations and variances, for example. Some embodiments of the methods disclosed herein consider block based variances, and color sampling and luminance levels in finding the resolution and color subsampling format. The methods determine the best match between the data sequence and potential resolution and subsampling possibilities by calculating strength of correlations or minimal variances, for example.

According to one aspect of the present principles, there is provided a method for detecting a format of image data. The image data can be that of a single image, a part of an image, or a video sequence or portion thereof. The method comprises receiving a portion of an image and selecting a format comprising an image resolution and a subsampling format from a plurality of potential formats. The method further comprises calculating a statistic of at least a portion of the image data based on the selected format, and storing the calculated statistic for the selected format. The steps of selecting, calculating, and storing for each of said plurality of potential other formats is repeated. The method further comprises comparing the calculated statistic corresponding to each of said selected formats and selecting for further processing one of the plurality of formats responsive to the comparing step.

According to another aspect of the present principles, there is provided an apparatus for detecting a format of image data. The apparatus comprises a receiver to receive a portion of an image and a first selector to select a format comprising an image resolution and a subsampling format from a plurality of potential formats. The apparatus further comprises compute circuitry to generate a statistic of at least a portion of the image data based on the selected format. The apparatus further comprises memory to store the generated statistic for the selected format, and logic circuitry to cause the first selector, compute circuitry, and memory to operate on each of the plurality of potential other formats. The apparatus further comprises a comparator operating on the calculated statistic corresponding to each of the selected formats and a second selector that picks one of the plurality of formats, responsive to the comparator, for further processing.

These and other aspects, features and advantages of the present principles will become apparent from the following detailed description of exemplary embodiments, which are to be read in connection with the accompanying drawings.

### BRIEF DESCRIPTION OF THE DRAWINGS

FIG. 1 shows an example of color subsampling used in accordance with the present principles.

FIG. 2 shows an adjacent graph in accordance with the present principles.

FIG. 3 shows an adjacent matrix in accordance with the present principles.

FIG. 4 shows an exemplary embodiment of a method for using the spatial statistic dispersion to detect the resolution and sub-sampling format of a picture in accordance with the present principles.

FIG. 5 shows an exemplary embodiment of a method for using the temporal statistic dispersion to detect the resolution and sub-sampling format of a picture in accordance with the present principles.

FIG. 6 shows an exemplary embodiment of a method for using the adjacency matrix to detect the resolution and sub-sampling format of a picture in accordance with the present principles.

FIG. 7 shows an exemplary embodiment of a method for using the histogram difference to detect the resolution and sub-sampling format of a picture in accordance with the present principles.

FIG. 8 shows an embodiment of an apparatus to detect the resolution and subsampling format of a picture in accordance with the present principles.

### DETAILED DESCRIPTION

The principles described herein relate to automatic detection of the resolution and color subsampling format of digital images or video sequences from raw image or video data. In much of the discussion, when video sequences are mentioned, it should be noted that the same color subsampling format can be applied to an individual image as well.

Digital video sequences, as well as digital images, are coded and stored in a variety of resolutions and formats. Many common formats separately code the luminance and chrominance information in several different resolutions, typically using two chroma channels and one luma channel. In addition, most of the formats use color subsampling, so that the resolution of the individual chroma channels is less than that of the luma channel.

Digital compression schemes, such as MPEG for video and JPEG for images, typically use a YCbCr color format, although it is commonly called YUV. The Cb and Cr chroma channels are chroma difference channels whose values represent the deviations from grey on blue-yellow and red-cyan chrominance axes, respectively. Strictly speaking, YUV refers to analog component video, but since YCbCr is commonly referred to as YUV, in this application when YUV is mentioned, it is actually YCbCr, unless otherwise noted.

The YUV digital encoding format can be used with various video (or image) resolutions. Pixel resolutions can range, for example, from 240 horizontal pixels (H)×160 vertical pixels (V) pixels, to 2060 (H)×2048 (V). For every possible video resolution, color information can be subsampled to varying degrees to form the U and the V channels.

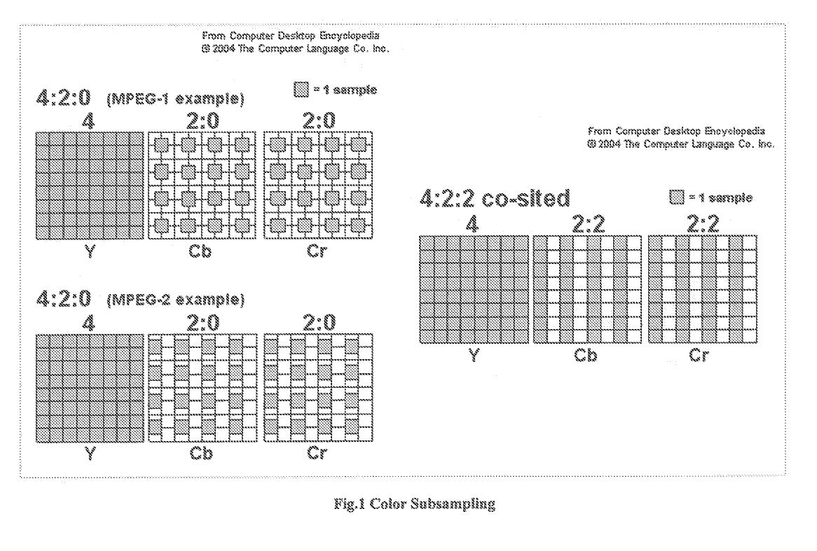

So, for example, a 1920 (H)×1080 (V) video sequence will have Y information at a 1920×1080 pixel resolution, but the U and the V channels may be subsampled so that the resolution of each of the U and the V channels is, for example, 960×540. In this case, the U and the V channels are half the resolution of the Y channel in both the horizontal and vertical directions. Therefore, the density of each of the U and the V channels is one-fourth that of the corresponding luma channel because for every four luma pixels, there will be one corresponding U sample and one corresponding V sample. This type of subsampling, in which the chroma channels are subsampled by a factor of two in both the horizontal and vertical directions relative to the luma resolution, is referred to as 4:2:0 format, which corresponds to the relative sampling ratios of the components Y:U:V. FIG. 1 shows the 4:2:0 format. A 4:1:1 format has chroma components with one-fourth the horizontal resolution of the luma resolution, and the same vertical resolution as luma.

The most common format for digital information is known as 4:2:2. This format has chroma components with one-half the horizontal resolution as luma and the same vertical resolution as luma. The professional CCIR 601 digital video format uses this format for YCbCr signals. High-end video equipment that processes uncompressed signals uses a 4:4:4 format having identical resolutions for both the luma and chroma components.

The present invention is directed to methods and apparatus for automatically detecting the image/video resolution and color subsampling format from image/video data. In at least one embodiment, the method comprises one or more of the following: finding the spatial correlation inside a raw data sequence based upon a look-up table or the temporal correlation among data sequence using at least one of block based variance, color sampling and luminance level, finding strength of correlation and finding the best match point.

In embodiments of the present invention, an assumption is made regarding the order and spacing of the luma and chroma information in the raw image data. Various statistics can be computed based on these assumptions and used individually, or in combinations, to help to determine the resolution and color subsampling format of an image or video sequence.

The samples of the raw image data are sampled and stored in specific order depending on the format. The MPEG-2 coding standard, for example, stores the samples of each of the luma blocks of a macroblock consecutively, followed by the samples of the Cb blocks for that macroblock, followed by the Cr blocks for that macroblock. For the case of 4:2:0 video, four luma blocks are followed by a single Cb block and then a single Cr block.

The present invention uses knowledge of the specific ordering of the luma and chroma blocks for each potential resolution and color subsampling combination in the plurality of formats tested to determine which ordering best fits the raw image data. The format corresponding to the ordering that best fits the raw image data is determined to be the resolution/color subsampling of the raw image. For example, raw image data that is 1920×1080 resolution and has color subsampling format of 4:2:0 may have high correlation between the four luma blocks that are spaced 120 macroblocks apart (1920 horizontal pixels per line/16 horizontal pixels per macroblock=120 macroblocks per line). Similarly, the corresponding Cb and Cr blocks immediately following the four luma macroblocks may have similar correlation with Cb and Cr blocks following the four macroblocks spaced 120 macroblocks apart. When the statistics for each potential resolution/color subsampling combination are calculated, the ordering that best fits the raw image data is determined to be the resolution/color subsampling of the raw image. In at least one embodiment of the present invention, various statistics can be calculated and combined in some weighted fashion to generate a decision statistic for each resolution/subsampling format.

In another embodiment, the statistical method or methods used can be determined by content, or the processing capability available. For example, sporting events may use temporal statistic dispersion metrics, or offline processing may use the histogram difference.

Raw image or video sequence data often arrives at production facilities in unknown resolutions or subsampling formats. With large volumes of data, it would be an arduous task for a compressionist to try processing the data assuming a large number of different formats. In the case of content in YUV format, there is no capability to store metadata that could be used to indicate the resolution and format. The following methods and apparatus seek to provide a solution to this shortcoming by finding the best correlation, either temporally and/or spatially, between parts of an image or between frames of video, or by finding the smallest variances over these same images or frames.

The assumptions made regarding the order and spacing of the luma and chroma information in the raw image data are used to compute various statistics that can be used individually, or in combinations, to help to determine the resolution and color subsampling format of an image or video sequence. A background on some of the statistics is useful.

Modern statistics and probability theory use statistic dispersion such as the standard deviation to measure the variability or diversity of random variables or samples. The statistic dispersion shows how much the samples vary from the average. Lower statistic dispersion means that the data closely clusters to the mean. On the other hand, higher statistic dispersion indicates that the samples or random variables spread out over a large range of values. We can describe the statistic dispersion d as the L norm statistics:

L¹ norm statistics indicate the extent that the median minimizes the absolute deviation. The average absolute deviation of a set {x₁, x₂, . . . , xₙ} with the median m (m can also be mean; if so, the deviation is called mean absolute deviation) is:

$$‖ {L}^{1} ‖ = \frac{1}{n} {\sum }_{i = 1}^{n} \vert {x}_{i} - m \vert \qquad ( 1 )$$

L² norm statistics indicate the extent that the median minimizes the standard deviation. The standard deviation of a set {x₁, x₂, . . . , xₙ} with the average of mean μ is:

$$‖ {L}^{2} ‖ = \sqrt{\frac{1}{n} {\sum }_{i = 1}^{n} {( {x}_{i} - μ )}^{2}} \qquad ( 2 )$$

Lⁿ norm statistics indicate the extent that the mid-range minimizes the maximum absolute deviation.

### Adjacency Matrix

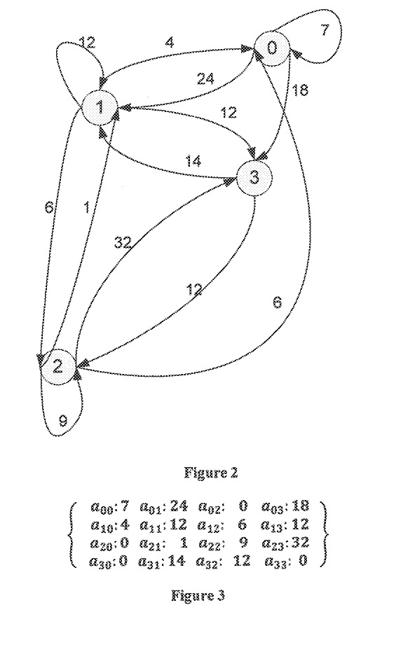

In mathematics, an adjacency matrix represents the particular nodes of a graph that are adjacent to other particular nodes. The adjacency matrix of a finite graph G of n vertices is the n×n matrix M where the entry aᵢⱼ is the number of edges from node i to node j. FIG. 2 shows an adjacent graph, and FIG. 3 shows its adjacent matrix. In the FIG. 3, a₀₀ stands for the node 0 to itself and its value.

The adjacency matrix can define the temporal correlation between two frames using the following formula:

$${C}_{t , t + 1} = {\sum }_{i = 0}^{N - 1} {\sum }_{j = 0}^{N - 1} \frac{{a}_{i , j}^{t , t + 1}}{{p}_{i}^{t} {p}_{j}^{t + 1}} \qquad ( 3 )$$

where C_{t,t+1} stands for the temporal correlation, a_{i,j}^{t,t+1} is an entry of an adjacency matrix and corresponds to the total number of elements with pixel value i in frame t that has pixel value j in frame t+1. pᵢ^{t} represents the total number of pixels with value i in the frame t. pⱼ^{t+1} represents the total number of pixels with value j in the frame t+1.

### Histogram Difference

The histogram detection algorithm is based on the assumption that two consecutive video frames share similar content. Let hᵢ be the number of pixels with the value i in a frame, let N be the total number of pixels, where R is the gray level range, t is the current frame number and t+1 is the next frame number. The histogram difference H_{t,t+1} is defined as:

$${H}_{t , t + 1} = \frac{1}{N} {\sum }_{i = 0}^{R} \vert {h}_{i}^{t} - {h}_{i}^{t + 1} \vert \qquad ( 4 )$$

### Sub-Sampling and Resolution Detection

A picture (or a video frame) has strong correlation between lines in the spatial domain. For a video frame, it also has strong correlation in the temporal domain.

### Build Resolution and Sub-Sampling Look-Up Tables or Checking Ranges

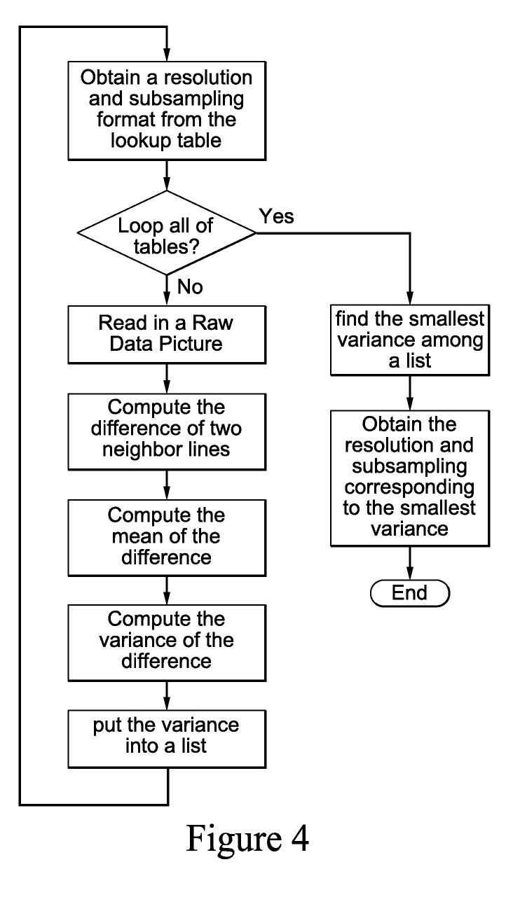

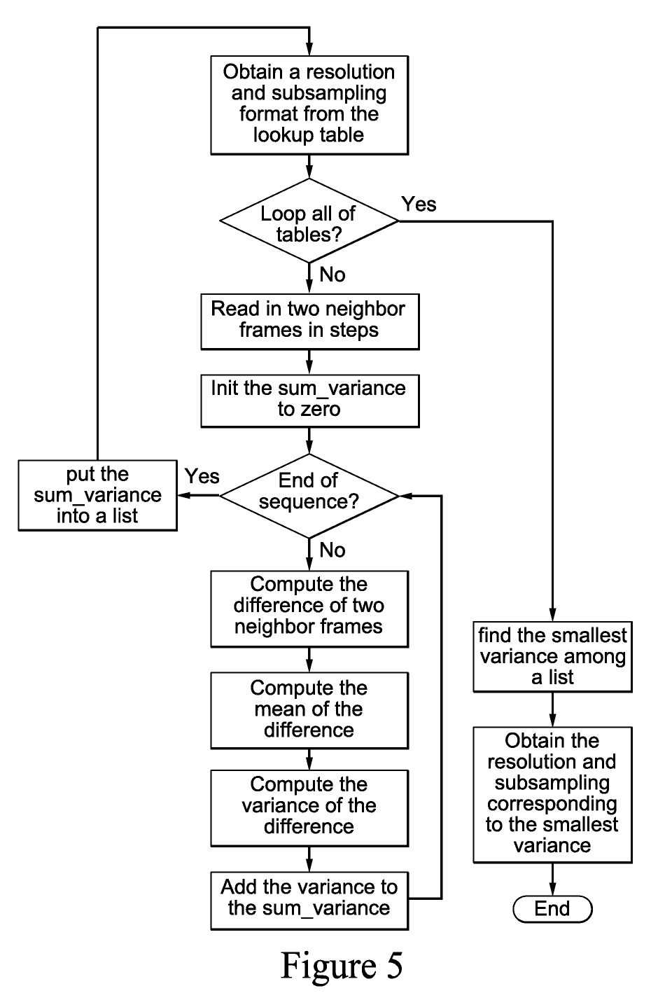

The first step involves building look-up tables to capture resolutions and sub-sampling formats. For example, to represent five color subsampling formats and 44 possible image resolutions, the following table can be constructed:
Sub-sampling={{4:4:4}, {4:2:2}, {4:2:0}, {4:1:1}, {4:0:0}}
Resolutions={{240, 160}, {320, 200}, {320, 240}, {480, 320}, {640, 480}, {654, 480}, {704, 480}, {704, 576}, {720, 480}, {720, 576}, {768, 576}, {786, 576}, {800, 480}, {800, 600}, {854, 480}, {872, 480}, {1024, 576}, {1024, 600}, {1024, 768}, {1048, 576}, {1152, 768}, {1152, 864}, {1280, 720}, {1280, 768}, {1280, 800}, {1280, 854}, {1280, 960}, {1280, 1024}, {1360, 768}, {1366, 768}, {1400, 1050}, {1440, 900}, {1440, 960}, {1440, 1080}, {1600, 900}, {1600, 1200}, {1680, 1050}, {1780, 956}, {1888, 1062}, {1920, 1080}, {1920, 1200}, {2048, 1080}, {2048, 1536}, {2060, 2048}}
   These look-up tables can be used in a particular embodiment of the flow charts in FIG. 4 and FIG. 5.

In addition, other characteristics of the raw image data can be used. For example, bit-depth is another parameter that can be included in the look-up tables. In this case, the look-up table would have the additional dimension of bit-depth:
Bit-depth={8, 10, 12, 16}
Sub-sampling={{4:4:4}, {4:2:2}, {4:2:0}, {4:1:1}, {4:0:0}}
Resolutions={{240, 160}, {320, 200}, {320, 240}, {480, 320}, {640, 480}, {654, 480}, {704, 480}, {704, 576}, {720, 480}, {720, 576}, {768, 576}, {786, 576}, {800, 480}, {800, 600}, {854, 480}, {872, 480}, {1024, 576}, {1024, 600}, {1024, 768}, {1048, 576}, {1152, 768}, {1152, 864}, {1280, 720}, {1280, 768}, {1280, 800}, {1280, 854}, {1280, 960}, {1280, 1024}, {1360, 768}, {1366, 768}, {1400, 1050}, {1440, 900}, {1440, 960}, {1440, 1080}, {1600, 900}, {1600, 1200}, {1680, 1050}, {1780, 956}, {1888, 1062}, {1920, 1080}, {1920, 1200}, {2048, 1080}, {2048, 1536}, {2060, 2048}}

### Use the Spatial Statistic Dispersion to Detect the Resolution and Sub-Sampling Format of a Picture

FIG. 4 shows a flow chart for an embodiment of a method 400 for detecting the resolution and sub-sampling format for a raw data picture using the spatial statistic dispersion.

The method starts at step 410. Following step 410, the method proceeds to step 420 comprising obtaining a resolution and sub-sampling format from resolution and sub-sampling look-up tables. At step 430, a check is performed to determine whether all resolutions and sub-sampling formats have been looped. If yes, the method proceeds to step 490, otherwise, go to step 440. In step 440, a raw data picture is read, based on the resolution and sub-sampling format from step 420. Following step 440, step 450 comprises computing the difference between two neighboring lines. Following step 450, step 460 comprises obtaining the mean of difference values from step 450 and step 470 comprises computing the variance of the difference values from step 450. After step 470, step 480 comprises putting the variance into a storing list and then go back to step 420. If, at step 430, all of the values of the table have been looped, step 430 proceeds to step 490, comprising finding the smallest variance among a list. Step 495 follows step 490 and comprises obtaining the resolution and sub-sampling format based on the smallest variance from steps 470 and 480. The method ends at step 499.

### Use the Temporal Statistic Dispersion to Detect the Resolution and Sub-Sampling Format of a Video Sequence

FIG. 5 shows the flow chart for an embodiment of a method 500 for detecting the resolution and color subsampling format for a raw video sequence using the temporal statistic dispersion.

The method starts at step 510. Following step 510, the method proceeds to step 520 comprising obtaining a resolution and sub-sampling format from a resolution and sub-sampling look-up table. The method then proceeds to step 530 comprising checking whether all of resolutions and sub-sampling formats have been looped. If yes, go to step 532, otherwise, go to step 533. Step 533 comprises reading two neighbor raw data video frames. Step 535 follows step 533 and comprises initializing a variable sum_variance to zero. Following step 535, step 540 checks whether the current two neighbor frames are the end of the video sequence, if yes, go to step 545, otherwise, go to step 550. Step 550 comprises computing the difference between two neighbor frames. Following step 550, step 560 comprises computing the mean of difference from step 550. The method proceeds to step 570 comprising computing the variance of difference values found in step 550. Step 580 follows step 570 and comprises adding the variance to sum_variance, and subsequently going back to step 540 to determine whether the end of the sequence has been reached. If the end of sequence has been reached, the method proceeds from step 540 to step 545 comprising putting the sum_variance to a storing list, then going back to step 520.

If, at step 530, it is determined that all of the resolutions and color subsampling formats have been looped, the method proceeds from step 530 to step 532 comprising finding the smallest sum_variance among a list. The method proceeds from step 532 to step 534 comprising obtaining the resolution and sub-sampling format based on the smallest sum_variance from step 532.

### Use the Adjacency Matrix to Detect the Resolution and Sub-Sampling Format of a Video Sequence

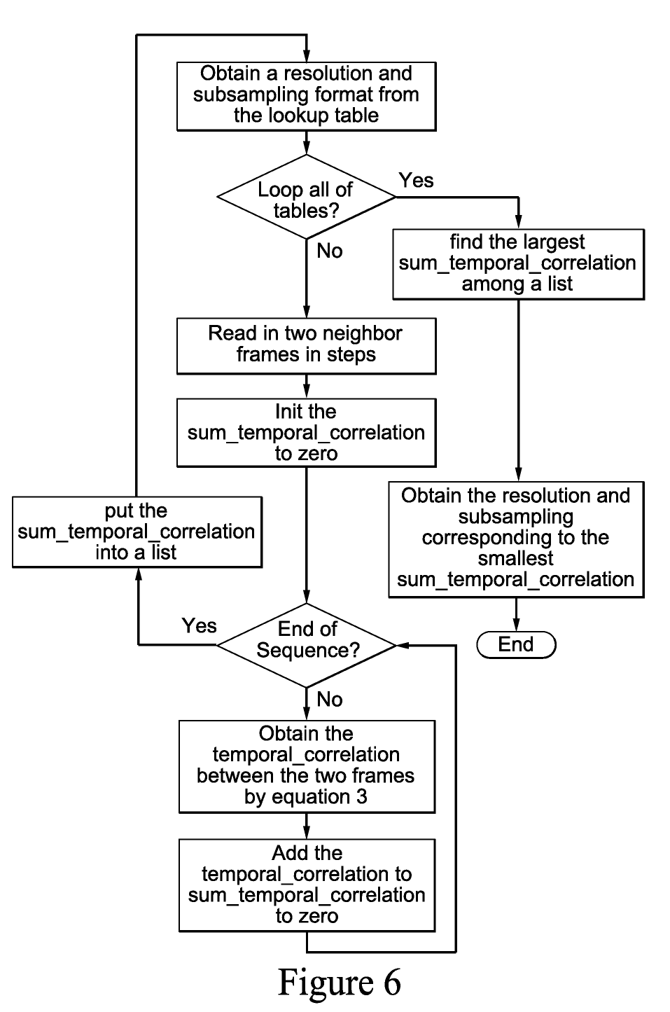

FIG. 6 shows the flow chart for an embodiment of a method 600 for detecting the resolution and color subsampling format for a raw video sequence using the adjacency matrix.

The method starts at step 610 and proceeds to step 620 comprising obtaining a resolution and sub-sampling format from the resolution and sub-sampling look-up tables. The method then proceeds to step 630 comprising checking whether all of resolutions and sub-sampling formats have been looped. If yes, go to step 632, otherwise, go to step 640. Step 640 comprises reading two neighbor raw data video frames in the M frames distance (M is decided by the length of the sequence). The method proceeds to step 650 comprising initializing a variable, sum_temporal_correlation, to zero. The method proceeds to step 660, which comprises determining whether the current two neighbor frames are the end of the video sequence. If it is the end of the sequence, the method proceeds to step 665, and otherwise goes to step 670. Step 670 comprises computing the temporal correlation between two neighbor frames according to equation (3). The method then proceeds to step 680 comprising adding the temporal correlation to the sum_{—} temporal_correlation and go back to step 660. If the end of the sequence has been determined in step 660, the method proceeds to step 665 comprising storing the sum_temporal_correlation to a storing list and subsequently going back to step 620.

If, at step 630, all of resolutions and sub-sampling formats have been looped, the method proceeds to step 632 comprising finding the largest sum_temporal_correlation in the list. The method proceeds to step 634 comprising obtaining the resolution and subsampling corresponding to the largest sum_temporal_correlation and ends at step 636.

### Use the Histogram Difference to Detect the Resolution and Sub-Sampling Format of a Video Sequence

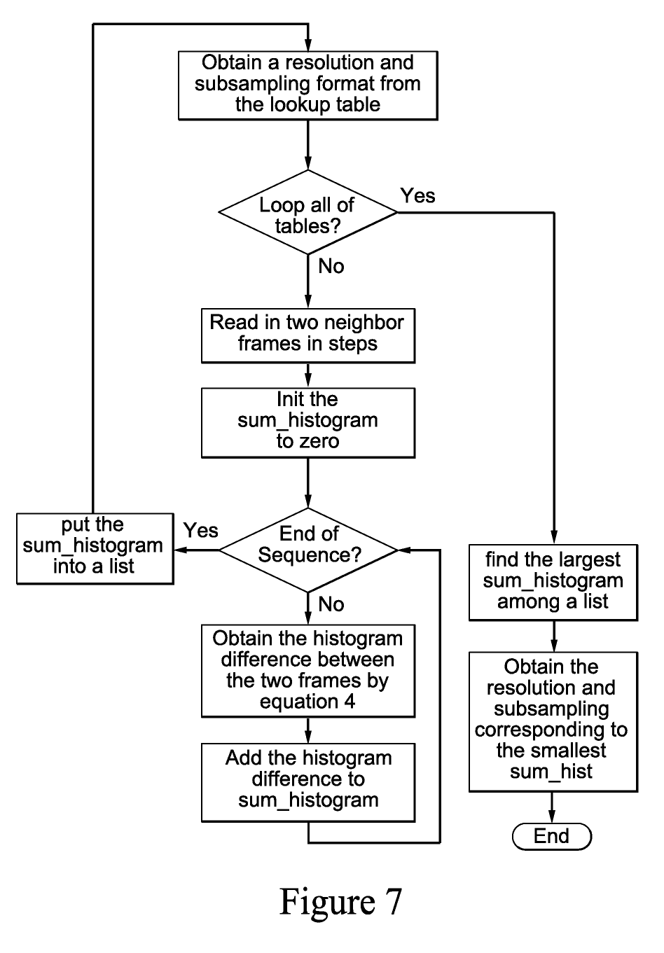

FIG. 7 shows the flow chart for an embodiment of a method 700 for detecting the resolution and color subsampling format for a raw video sequence using a histogram difference. The method begins at step 701 and proceeds to step 710 comprising obtaining a resolution and sub-sampling format from the resolution and sub-sampling look-up table. The method proceeds from step 710 to step 720 comprising determining whether all of resolutions and sub-sampling format have been looped. If they have been looped, go to step 722, otherwise, go to step 730. Step 730 comprises reading two neighboring raw data video frames in the M frames distance (M is decided by the length of the sequence). From step 730, the method proceeds to step 740 comprising initializing a variable sum_histogram to zero. The method proceeds to step 750 comprising determining whether the current two neighbor frames are the end of the video sequence. If it is determined that they are the end of the sequence, the method proceeds to step 755, otherwise, the method proceeds to step 760 comprising computing a histogram difference between two neighbor frames according to equation (4). Following step 760, the method proceeds to step 770 comprising adding the histogram difference to the sum_histogram and proceeding back to step 750. If, at step 750, it is determined that the two neighbor frames are the end of a sequence, the method proceeds to step 755 comprising storing the variable sum_histogram to a storing list and go back to step 710.

If, at step 720, it is determined that all of the resolutions and color subsampling formats have been looped, the method proceeds to step 722 comprising finding the largest sum_histogram in the list generated by step 755. The method then proceeds to step 724 comprising obtaining the resolution and color subsampling format corresponding to the largest sum_histogram value in the list. The method then ends at step 726.

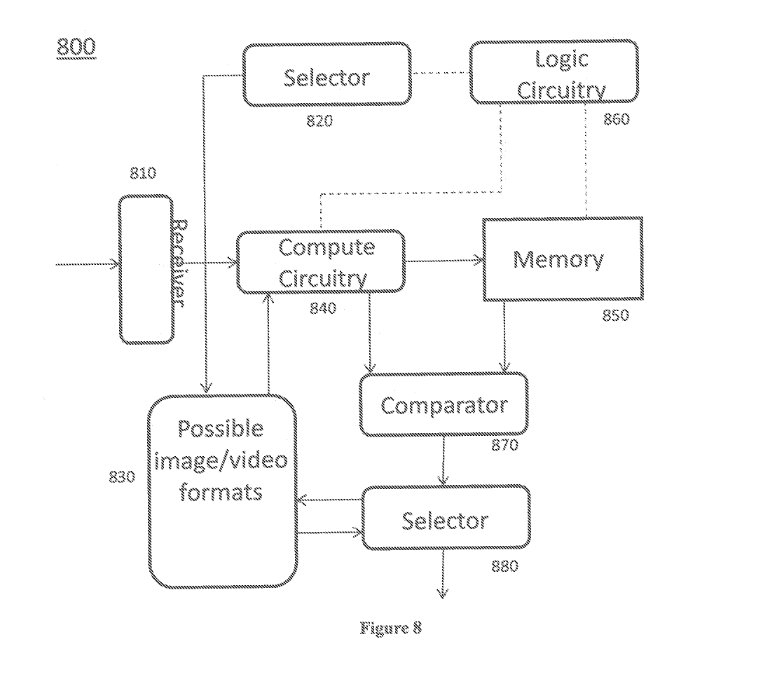

FIG. 8 shows one embodiment of an apparatus 800 for detecting the resolution and color subsampling format for a raw video sequence. The apparatus is comprised of a receiver 810 whose input port is in signal connectivity with raw input image data. The apparatus is further comprised of a first selector 820 to select a format comprising an image resolution and a subsampling format from a plurality of potential formats 830. The apparatus is also comprised of compute circuitry 840 to generate a statistic of at least a portion of the image data based on the selected format and memory 850 to store the generated statistic for the selected format. The apparatus is further comprised of logic circuitry 860 to cause said first selector 820, compute circuitry 840, and memory 850 to operate on each of said plurality of potential other formats. The apparatus is further comprised of a comparator 870 operating on the generated statistic corresponding to each of said selected formats and a second selector 880 that picks one of said plurality of formats 830, responsive to said comparator 870, for further processing.

The statistics described herein, such as the spatial statistic dispersion, temporal statistic dispersion, adjacency matrix, and histogram difference can be used individually or in combination to determine the resolution and color subsampling of raw image or video data. If used in combination, the various statistics can each be weighted to come up with a decision to determine the resolution and color subsampling format of the raw image or video data. Also, the present principles should not be viewed as being limited to the aforementioned statistics as other statistics can be used, individually or in combination.

One or more implementations having particular features and aspects of the presently preferred embodiments of the invention have been provided. However, features and aspects of described implementations can also be adapted for other implementations. For example, these implementations and features can be used in the context of other video devices or systems. The implementations and features need not be used in a standard.

Reference in the specification to “one embodiment” or “an embodiment” or “one implementation” or “an implementation” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment” or “in one implementation” or “in an implementation”, as well any other variations, appearing in various places throughout the specification are not necessarily all referring to the same embodiment.

The implementations described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or computer software program). An apparatus can be implemented in, for example, appropriate hardware, software, and firmware. The methods can be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end users.

Implementations of the various processes and features described herein can be embodied in a variety of different equipment or applications. Examples of such equipment include a web server, a laptop, a personal computer, a cell phone, a PDA, and other communication devices. As should be clear, the equipment can be mobile and even installed in a mobile vehicle.

Additionally, the methods can be implemented by instructions being performed by a processor, and such instructions (and/or data values produced by an implementation) can be stored on a processor-readable medium such as, for example, an integrated circuit, a software carrier or other storage device such as, for example, a hard disk, a compact disc, a random access memory (“RAM”), or a read-only memory (“ROM”). The instructions can form an application program tangibly embodied on a processor-readable medium. Instructions can be, for example, in hardware, firmware, software, or a combination. Instructions can be found in, for example, an operating system, a separate application, or a combination of the two. A processor can be characterized, therefore, as, for example, both a device configured to carry out a process and a device that includes a processor-readable medium (such as a storage device) having instructions for carrying out a process. Further, a processor-readable medium can store, in addition to or in lieu of instructions, data values produced by an implementation.

As will be evident to one of skill in the art, implementations can use all or part of the approaches described herein. The implementations can include, for example, instructions for performing a method, or data produced by one of the described embodiments.

A number of implementations have been described. Nevertheless, it will be understood that various modifications can be made. For example, elements of different implementations can be combined, supplemented, modified, or removed to produce other implementations. Additionally, one of ordinary skill will understand that other structures and processes can be substituted for those disclosed and the resulting implementations will perform at least substantially the same function(s), in at least substantially the same way(s), to achieve at least substantially the same result(s) as the implementations disclosed. Accordingly, these and other implementations are contemplated by this disclosure and are within the scope of this disclosure.

1. A method for detecting a format of image data, comprising:
selecting a first format;
calculating a statistic of at least a portion of the image data based on the first format;
storing the calculated statistic for the first format;
repeating said selecting, calculating, and storing steps for a plurality of further formats;
comparing the calculated statistic corresponding to each of said formats; and,
selecting for further processing of said image one of said plurality of formats responsive to said comparing step.

2. The method of claim 1, wherein said format comprises at least one of an image resolution and a subsampling structure.

3. The method of claim 2, wherein said subsampling structure is for chroma information.

4. The method of claim 1, wherein said format comprises additional characteristics of the image data.

5. The method of claim 1, wherein said portion of the image data is selected randomly.

6. The method of claim 1, wherein said calculating step comprises using a spatial statistic dispersion as said statistic.

7. The method of claim 1, wherein said calculating step comprises using a temporal statistic dispersion as said statistic.

8. The method of claim 1, wherein said calculating step comprises using an adjacency matrix as said statistic.

9. The method of claim 1, wherein said calculating step comprises using a histogram difference as said statistic.

10. The method of claim 1, wherein said calculating step comprises using a combination from at least two of a spatial statistic dispersion, a temporal statistic dispersion, an adjacency matrix and a histogram difference as said statistic.

11. The method of claim 10, wherein the statistics used are based on the content of the image data.

12. The method of claim 10, wherein the statistics used are based on available processing capability.

13. An apparatus for detecting a format of image data, comprising:
a first selector to select a first format;
compute circuitry to calculate a statistic of at least a portion of the image data based on the first format;
memory to store the calculated statistic for the first format;
logic circuitry to cause said first selector, compute circuitry, and memory to operate for a plurality of further formats;
a comparator to compare the calculated statistic corresponding to each of said formats; and,
a second selector to pick, for further processing of said image, one of said plurality of formats responsive to said comparator.

14. The apparatus of claim 13, wherein said compute circuitry uses a spatial statistic dispersion as said statistic.

15. The apparatus of claim 13, wherein said compute circuitry uses a temporal statistic dispersion as said statistic.

16. The apparatus of claim 13, wherein said compute circuitry uses an adjacency matrix as said statistic.

17. The apparatus of claim 13, wherein said compute circuitry uses a histogram difference as said statistic.

18. The apparatus of claim 13, wherein said compute circuitry uses a combination comprising a spatial statistic dispersion, a temporal statistic dispersion, an adjacency matrix and a histogram difference as said statistic.

19. A method for detecting a format of image data, comprising:
selecting a first format comprising an image resolution and a subsampling format;
calculating a statistic of at least a portion of the image data based on the first format;
storing the calculated statistic for the first format;
repeating said selecting, calculating, and storing steps for a plurality of further formats;
comparing the calculated statistic corresponding to each of said formats;
and,
selecting for further processing of said image one of said plurality of formats responsive to said comparing step.

20. An apparatus for detecting a format of image data, comprising:
a first selector to select a first format comprising an image resolution and a subsampling format;
compute circuitry to calculate a statistic of at least a portion of the image data based on the first format;
memory to store the calculated statistic for the first format;
logic circuitry to cause said first selector, compute circuitry, and memory to operate on said plurality of further formats;
a comparator to compare the calculated statistic corresponding to each of said formats; and,
a second selector that picks, for further processing of said image, one of said plurality of formats responsive to said comparator.
